(19) United States
(12) Patent Application Publication
(10) Pub. No.: US 2010/0025243 A1
(43) Pub. Date: Feb. 4, 2010

(54) METHOD FOR ROBUST CONTROL OVER A SOLUABLE FACTOR MICROENVIRONMENT WITHIN A THREE-DIMENSIONAL GEL MATRIX

(76) Inventors: David J. Beebe, Monona, WI (US); Vinay V. Abhyankar, Dublin, CA (US); Michael W. Toepke, Normal, IL (US)

Correspondence Address: BOYLE FREDRICKSON S.C., 840 North Plankinton Avenue, MILWAUKEE, WI, 53203, US

(21) Appl. No.: 12/184,408

(22) Filed: Aug. 1, 2008

(51) Int. Cl. B01D 57/02

(52) U.S. Cl. 204/455

(57) ABSTRACT

A method is provided of generating a gradient within gel matrix received in a channel of a microfluidic device. A source reservoir in communication with the input of the channel is filled with a first fluid. A sink reservoir in communication with the output of the channel is filled with a second fluid. A soluble factor is deposited in the source reservoir such that the soluble factor diffuses into the channel and forms the gradient. The soluble factor in source reservoir is replenished to maintain the gradient in a generally pseudo-steady state and the second fluid in the sink reservoir is replaced.

### FIELD OF THE INVENTION

This invention relates generally to microfluidic devices, and in particular, to a method for robust control over a soluble factor microenvironment within a three-dimensional gel matrix.

### BACKGROUND AND SUMMARY OF THE INVENTION

The hallmark characteristic of the in vivo environment is highly-regulated spatial and temporal control over the local cellular microenvironment. Phenotypic changes of observed organisms are thought to result from an integration of complex, temporally-evolving autocrine/paracrine signaling factors, biophysical interactions, and mechanical contact with the protein laden extracellular matrix (ECM). Experimental work has confirmed that cells cultured on two-dimensional (2D) substrates tend to form monolayers of cells while even simple three-dimensional (3D) materials support cellular structures that appear morphologically similar to in vivo tissue. These observations have spawned great interest in translating 2D assays to 3D matrices. While 3D matrices provide appropriate mechanical contact and architecture, such scaffolds alone are not sufficient to address a critical component of the in vivo environment, namely, the role of the soluble factor microenvironment.

The fundamental importance of biomolecular gradients during embryogenesis, cellular differentiation, and the immune response has precipitated a multitude of in vitro assays over the past thirty years. Methods such as the Transwell Assay, Zigmond Chamber, and Micropipette Assay have been widely used to qualitatively study cellular responses to soluble factors within 2D cell culture constructs. While these traditional methods have shed light onto cellular responses and molecular signaling mechanisms, they are not able to develop the robust, predictable gradients that are necessary to draw quantitative correlations between cellular responses and soluble factor cues. Ultimately, these quantitative correlations are necessary to enable increasingly sophisticated model systems that provide accurate representations of in vivo cellular behavior.

Through the development of reproducible, predictable, and defined soluble factor gradients, microfluidic technologies have helped to overcome the limitations of traditional methods. Microfluidic methods have been applied to quantitatively study the migratory responses of cancer cells and leukocytes, and to investigate the differentiation of neuronal cells. While the defined environments provided by microfluidic methods have proven to be beneficial within 2D culture constructs, an analogous degree of control has not yet been extended to 3D scaffolds. As the quest toward physiologically relevant model systems progresses, the ability to create defined chemical environments becomes a valuable experimental tool that can be used to study migration and reorganization of cell populations within a 3D matrix. The ability to spatially and temporally control and modulate soluble factor pulses and gradients within such scaffolds currently remains an emerging field of research.

Therefore, it is a primary object and feature of the present invention to provide a method that allows for robust soluble factor control within a 3D gel matrix.

It is a still further object and feature of the present invention to provide a method for generating a gradient within a 3D gel matrix.

It is a still further object and feature of the present invention to provide a method for generating a gradient within a 3D gel matrix that allows for the introduction of media into the gradient without generating convection.

It is a still further object and feature of the present invention to provide a method for generating a gradient within a 3D gel matrix therein that is simple to utilize and inexpensive to practice.

In accordance with the present invention, a method is provided of generating a gradient within a channel of a microfluidic device. The microfluidic device has a channel including an input and an output. The method comprises the steps of filling the channel with a gel and providing a source reservoir that communicates with the input of the channel. A sink reservoir is provided that communicates with the output of the channel. A soluble factor is deposited in the source reservoir such that the soluble factor diffuses into the channel and forms the gradient.

It is contemplated for the channel to have a generally v-shaped configuration or to be generally linear. The sink reservoir, the source reservoir and the channel have corresponding volumes. The volume of the sink reservoir is greater than the sum of the volumes of the source reservoir and the channel. Alternatively, the sink reservoir and the source reservoir have corresponding volumes wherein the volume of the sink reservoir is equal to the volume of the source reservoir.

The method may include the additional step of replenishing the soluble factor in source reservoir to maintain the gradient in a generally pseudo-steady state. In addition, the sink reservoir is filled with a fluid and replaced thereafter. An access port is provided in the microfluidic device. The access port communicates with the channel.

In accordance with a further aspect of the present invention, a method is provided of generating a gradient within a channel of a microfluidic device. The microfluidic device has a channel including an input and an output. The method includes the steps of filling the channel with a gel and filling a source reservoir in communication with the input of the channel with a first fluid. A sink reservoir in communication with the output of the channel is filled with a second fluid. A soluble factor is deposited in the source reservoir such that the soluble factor diffuses into the channel and forms the gradient.

The method also includes the additional step of polymerizing the gel. It is also contemplated for the channel to have a generally v-shaped configuration or to be generally linear. The sink reservoir, the source reservoir and the channel have corresponding volumes. The volume of the sink reservoir is greater than the sum of the volumes of the source reservoir and the channel. Alternatively, the sink reservoir and the source reservoir have corresponding volumes wherein the volume of the sink reservoir is equal to the volume of the source reservoir.

The method may include the additional step of replenishing the soluble factor in the source reservoir to maintain the gradient in a generally pseudo-steady state. In addition, the sink reservoir is filled with a fluid and the fluid is replaced thereafter. An access port is provided in the microfluidic device. The access port communicates with the channel.

In accordance with a still further aspect of the present invention, a method is provided for generating a gradient within a channel of a microfluidic device. The microfluidic device has a channel including an input and an output. The method includes the steps of filling the channel with a gel and polymerizing the gel within the channel. A source reservoir in communication with the input of the channel is filled with a first fluid. A sink reservoir in communication with the output of the channel is filled with a second fluid. A soluble factor is deposited in the source reservoir such that the soluble factor diffuses into the channel and forms the gradient. The soluble factor in the source reservoir is replenished to maintain the gradient in a generally pseudo-steady state and the second fluid in the sink reservoir is replaced.

It is contemplated for the channel to have a generally v-shaped configuration or to be generally linear. The sink reservoir, the source reservoir and the channel have corresponding volumes. The volume of the sink reservoir is greater than the sum of the volumes of the source reservoir and the channel. Alternatively, the sink reservoir and the source reservoir have corresponding volumes wherein the volume of the sink reservoir being is equal to the volume of the source reservoir. An access port may be provided in the microfluidic device. The access port communicates with the channel.

### BRIEF DESCRIPTION OF THE DRAWINGS

The drawings furnished herewith illustrate a preferred construction of the present invention in which the above advantages and features are clearly disclosed as well as others which will be readily understood from the following description of the illustrated embodiments.

In the drawings:

FIG. 1 is an isometric view of a microfluidic device for effectuating the methodology of the present invention;

FIG. 2 is a cross sectional view of the microfluidic device taken along line 2-2 of FIG. 1;

FIG. 3 is a cross sectional view of the microfluidic device taken along line 3-3 of FIG. 2;

FIG. 4 is a cross sectional view of the microfluidic device, similar to FIG. 3, showing an alternate embodiment of a channel therein; and

FIG. 5 is a cross sectional view, similar to FIG. 2, showing an alternate embodiment of microfluidic device for effectuating the methodology of the present invention.

### DETAILED DESCRIPTION OF THE DRAWINGS

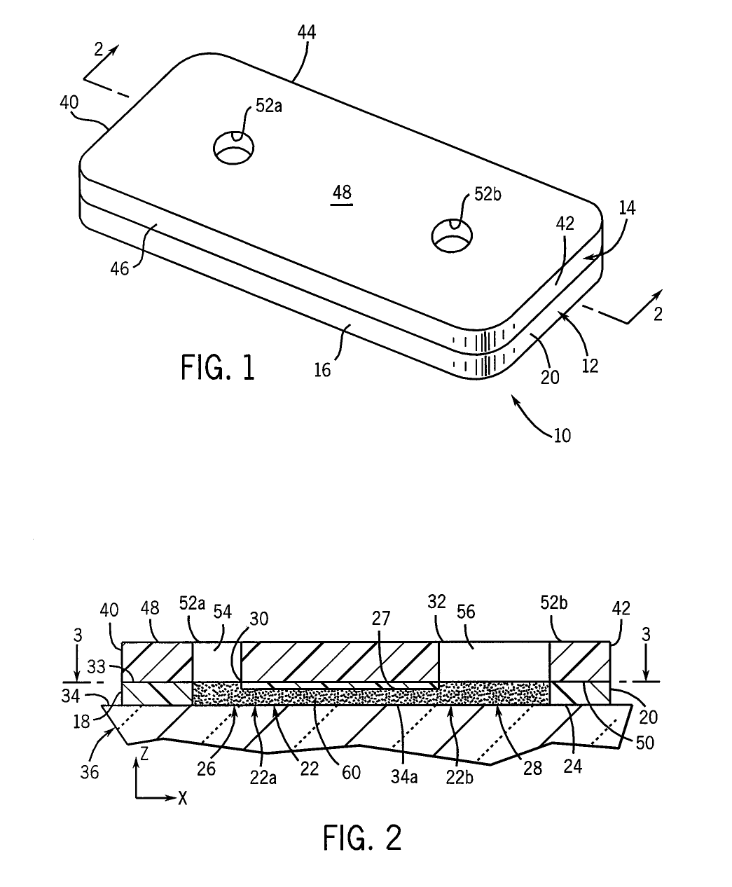

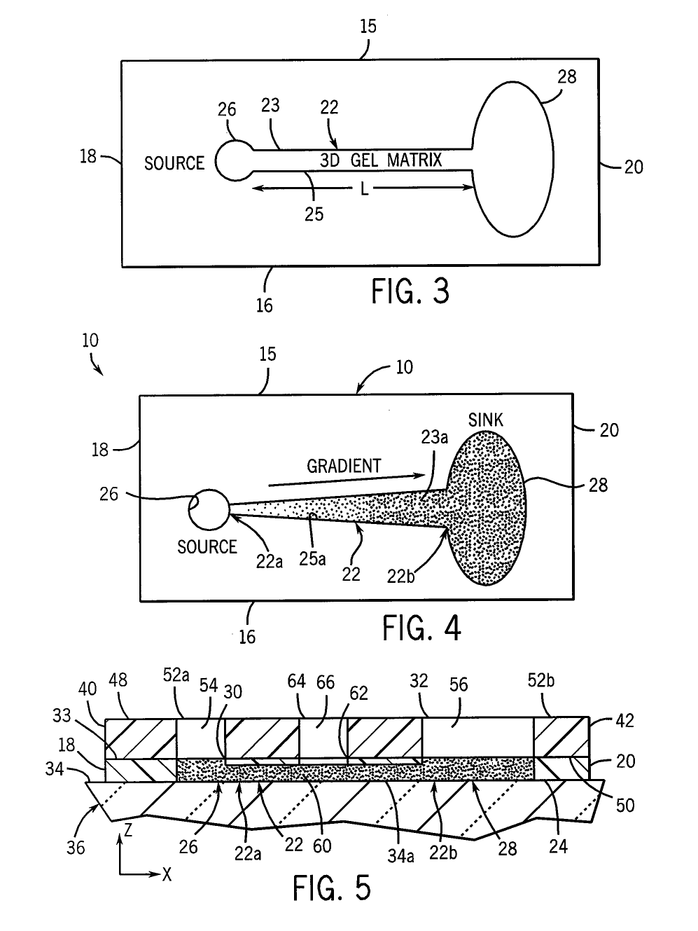

Referring to FIGS. 1-3, a microfluidic device in accordance with the present invention is generally designated by the reference numeral 10. It is intended for a user to utilize microfluidic device 10 in order to effectuate methodology of the present invention. It can be appreciated that microfluidic device 10 can have various configurations without deviating from the scope of the present invention. In the contemplated embodiment, microfluidic device 10 is fabricated from (poly)dimethylsiloxane (PDMS) using soft lithography and rapid prototyping. However, microfluidic device may be fabricated from other materials using other manufacturing techniques.

Microfluidic device 10 includes channel layer 12 and access layer 14 having generally rectangular configurations. Channel layer 12 is defined by first and second sides 15 and 16, respectively, and first and second ends 18 and 20, respectively. Channel 22 is provided in lower surface 24 of channel layer 12 and extends along a longitudinal axis such that a first end 22a of channel 22 communicates with a source region 26 and a second end 22b of channel 22 communicates with an enlarged sink region 28. Channel 22 is defined by first and second generally parallel sidewalls 23 and 25, respectively, interconnected by upper wall 27. In the depicted embodiment, sidewalls 23 and 25 are generally parallel to each other such that channel 22 is generally straight.

Access ports 30 and 32 are punched in upper surface 33 of channel layer 12 with a sharpened coring tool. It is intended for source port 30 to communicate with source region 26 and for sink port 32 to communicate with sink region 28. Lower surface 24 of channel layer 12 is positioned on upper surface 34 of a substrate 36, e.g., a microscope slide or the like, such that a portion 34a of upper surface 34 of substrate 36 partially defines channel 22. For reasons hereinafter described, sink region 28 in lower surface 24 of channel layer 12 has a volume greater than the diameter of source region 26.

Access layer 14 is defined by first and second ends 40 and 42, respectively, and first and second sides 44 and 46, respectively. Access layer 14 further includes upper surface 48 and lower surface 50 interconnected to upper surface 33 of channel layer 12. Access layer 14 is positioned on upper surface 33 of channel layer 12 such that first and second ends 40 and 42, respectively, of access layer 14 are aligned with corresponding first and second ends 18 and 20, respectively, of channel layer 12. Access layer 14 further includes first and second access ports 52a and 52b, respectively, which communicate with source reservoir 54 and sink reservoir 56, respectively. It is intended for source reservoir 54 and sink reservoir 56 to extend between upper surface 48 and lower surface 50 of access layer 14. It is further intended for source reservoir 54 and sink reservoir 56 to communicate with corresponding source and sink ports 30 and 32, respectively, through channel layer 12.

In operation, channel 22, source region 26, sink region 28, source port 30 and sink port 32 in channel layer 12 are loaded with an unpolymerized gel solution 60. The portion of gel solution 60 in source and sink ports 30 and 32, respectively, is leveled by removing excess gel solution from upper surface 33 of channel layer 12, e.g. with a sharp razor blade, prior to solidification. After polymerizing gel solution 60, access layer 14 is aligned on upper surface 33 of channel layer 14, as heretofore described. Gel thickness in the ports and channels is defined by the heights achieved during the photolithography process. Source and sink reservoirs 54 and 56, respectively, are then loaded with a user desired medium, e.g. deionized water or cell culture medium, through access ports 52a and 52b and the system is allowed to equilibrate in a humidified environment for a predetermined time period, e.g., at least one hour. Thereafter, in order to form a gradient within channel 22, a soluble factor such as a predetermined fluid having a known concentration of particles, cells, molecules, chemical species, organisms or the like, therein is introduced or loaded into microfluidic device 10 through access port 52a.

Linear and non-linear soluble factor gradients may be developed within a gel-filled channel by combining variable channel geometries with the principle of an infinite source and an infinite sink. The infinite source/sink concept is an idealized case where the concentrations at either end of a channel are held constant. The fixed boundary concentrations result in a steady state concentration profile between the two boundaries. The geometry of the channel connecting the source and sink reservoirs affects the steady state profile. More specifically, the concentration profile of the gradient in channel 22 develops according to the formula:

$$\frac{1}{A ( x )} ( \frac{d}{d x} ) ( A ( x ) ( \frac{d C}{d x} ) ) = 0 \qquad Equation ( 1 )$$

wherein A(x) is the spatially varying cross-sectional area of channel 22 and x is the spatial coordinate.

In view of the foregoing, it can be appreciated that straight channels yield linear profiles and v-shaped (“wedge”) channels produce logarithmic profiles. As such, it is contemplated to alter the profile of channel 22 without deviating from the scope of the present invention. By way of example, referring to FIG. 4, it is contemplated for channel 22 to be defined be first and second sidewalls 23a and 25a, respectively, that diverge from each other such that channel 22 has a v-shaped or “wedge” configuration.

Referring back to FIGS. 1-3, during gradient formation, the finite volume source begins to deplete as the soluble factor diffuses from the source reservoir 54 into channel 22. After a setup time tₛₛ, the gradient reaches a pseudo-steady state profile along the length of channel 22 and the concentration of the soluble factor at the input of channel 22 is in equilibrium with the concentration of the soluble factor within the source reservoir 54 (hereinafter the “source concentration”) Cₛ. The depletion of the source concentration leads to a situation where Cₛ is less than the initial input concentration C₀. Because source and sink reservoirs 54 and 56, respectively, have finite volumes, source concentration Cₛ depletes as a function of time. As such, the soluble factor in source reservoir 54 must be replenished in an appropriate manner to maintain the developed gradient in channel 22. As described below, the timing of the initial replenishment of the soluble factor in source reservoir 30 plays an important role in defining the concentration range of the gradient. Because the concentration at the input of the channel is less than the initial input concentration, replacing the soluble factor within source reservoir 54 such that C₀>Cₛ drives the gradient away from its pseudo-steady state and disturbs the system. In other words, the concentration of the soluble factor in channel 22 will gradually increase until a shifted pseudo-steady state is reached.

In view of the foregoing, it can be appreciated that the source solution must be replenished at C=Cs (see Equation 1) to minimize gradient disturbances.

Cₛ=C₀e^{-t/τ} Equation (2)

wherein Cₛ is the source concentration; C₀ is the initial concentration; t is time; and τ is a source time parameter.

The source time parameter τ is defined as follows:

τ=Vₛh_{gel}/D_{avg}A_{c} Equation (3)

wherein Vₛ is the volume of solution in the source reservoir 54; h_{gel} is the height of the gel in the source port 30; D_{avg} is the average diffusivity of the soluble factor in the source reservoir 54 and in the gel; and A_{c} is the limiting cross-sectional area at the entrance of channel 22.

The source time parameter τ is used to determine the depletion of the source concentration Cₛ. Hence, source time parameter τ serves as a guide to determine the concentration at which source reservoir 54 should be replenished to minimize disruption of the gradient in channel 22. Source time parameter τ can be extended (therefore decreasing the amount of source depletion for a given amount of time) by increasing the volume of source reservoir 54, increasing the height of the gel in the port, or decreasing the limiting cross-sectional area at the input of channel 22.

As described, the gradient in channel 22 may be maintained for a matter of minutes or for an extended period of time, e.g. weeks. However, the concentration in source reservoir 54 must be replenished periodically in order to maintain the gradient for extended periods of time. The frequency of the source solution replacement (C=Cs) is dictated by system time parameter λ.

C=Cₛe^{-t/λ} Equation (4)

wherein Cₛ is the source concentration; C₀ is the initial concentration; t is time; and λ is a system time parameter.

The system time parameter λ is defined as follows:

λ=VₛLₜ/D_{gel}A_{c} Equation (5)

wherein D_{gel} is the diffusivity of the soluble factor in the source reservoir 54 and in the gel; and Lₜ corresponds to the total diffusion distance from the source solution to the sink and is calculated according to the expression:

Lₜ=L+h_{gel} Equation (6)

wherein L is the length of channel 22.

The frequency of replenishment depends on two factors: one physical and one logistic. The physical consideration is one of continued source depletion, namely, waiting an extended period of time between replenishment affects the stability of the gradient. The logistical issue is one of convenience. Frequent media changes (e.g. every 3-6 hours) leads to labor-intensive gradient maintenance and increases reagent usage.

It can be appreciated that sink reservoir 56 has a volume that is several orders of magnitude larger than the combined volume of source reservoir 54 and channel 22. As a result, sink reservoir 56 is less sensitive to fluid replenishment (in other words, sink reservoir acts more like an infinite sink). However, a user may replace the fluid within sink reservoir 56 at the same time as source reservoir 54 is refilled for convenience. While the volume of source reservoir 54 can be increased to match the volume of sink reservoir 56, it is highly desirable to minimize the volume of source reservoir 54 to a practical lower limit for reagent usage in long term experiments.

Alternatively, it is contemplated to utilize the concept of sources and sinks to create opposing gradients with one concentration source acting as a sink for the other concentration source. More specifically, microfluidic device 10 may be fabricated such that source reservoir 54 and sink reservoir 56 have generally equal volumes. Thereafter, in order to form the opposing gradients within channel 22, a first soluble factor such as a predetermined fluid having a known concentration of particles, cells, molecules, chemical species, organisms or the like, therein is introduced or loaded into microfluidic device 10 through access port 52a. A second first soluble factor such as a predetermined fluid having a known concentration of particles, cells, molecules, chemical species, organisms or the like, therein is introduced or loaded into microfluidic device 10 through access port 52b. As described, opposing gradients develop within gel-filled channel 22.

Referring to FIG. 5, it is contemplated to provide one or more additional, centrally located dosing windows in microfluidic device 10 to either superimpose additional factors onto the existing overlapping profiles or to add cells to channel 22. By way of example, third port 62 is punched in upper surface 33 of channel layer 12 with a sharpened coring tool. It is intended for third port 62 to communicate with communicate with channel 22 at a location spaced from source region 26 and sink region 28. Access layer 14 further includes third access port 64 that communicates with dosing reservoir 66. It is intended for dosing reservoir 66 to extend between upper surface 48 and lower surface 50 of access layer 14. It is further intended for dosing reservoir 66 to communicate with corresponding third port 62 in channel layer 12. Third port 62, access port 64 and dosing reservoir 66 define a dosing window for providing access to the polymerized gel solution 60 in channel 22.

By providing one or more dosage windows in microfluidic device 10, a user may create transient pulses in channel 22. This, in turn, provides a user with temporal and spatial control over the local soluble factor microenvironment within channel 22. In addition, new cell populations may be introduced into channel 22 through the one or more dosage windows, thereby allowing a user to develop more complex in vitro model systems with spatial and temporal resolution. Even though the introduction of the new cell populations is diffusion-based, soluble factors can diffuse quickly over short distances. For example, a small molecule, i.e. (D=5×10⁻⁶ cm² sec⁻¹) can diffuse a distance of 10 microns in approximately 0.1 second (assuming the molecule does not react with polymerized gel 60), thereby allowing for rapid changes to the microenvironment over cellular scale lengths.

In addition, the one or more dosage windows in microfluidic device 10 may be used to guide a cell that is migrating along a stable gradient in channel 22. The cell could be “steered” by dosing an adjacent window with a new factor. Alternatively, two dosage windows adjacent to a cell could be dosed with different factors to create overlapping gradients on top of a stable gradient within channel 22. This platform mimics in vivo functionality wherein cells are simultaneously exposed to multiple stimuli and choose a preferential path. An assay of this type could help to elucidate signaling hierarchy between chemotactic factors.

As described, the use of 3D polymerized gels not only provides architecture similar to the in vivo, but also provides fluidic resistance to channel 22. The small diameter pores present throughout the gel volume enable fluids to be exchanged with minimum perturbation of the developed concentration profile. Long lasting gradients, coupled with transient doses, allow a user to more faithfully recreate in vivo environments, and provide new capabilities for in vitro investigations. It can be appreciate that the methodology of the present invention can used to examine the conditions that affect the differentiation of stem cells, promote (or inhibit) cancer metastasis, or direct cell orientation during early development. Further, since the methodology of the present invention requires only source and sink fluid replacement, a robotic system could be easily programmed to do such task.

Various modes of carrying out the invention are contemplated as being within the scope of the following claims particularly pointing out and distinctly claiming the subject matter, which is regarded as the invention.

We claim:

1. A method of generating a gradient within a channel of a microfluidic device, the microfluidic device having a channel including an input and an output, the method comprising the steps of:
filling the channel with a gel;
providing a source reservoir that communicates with the input of the channel;
providing a sink reservoir that communicates with the output of the channel; and
depositing a soluble factor in the source reservoir such that the soluble factor diffuses into the channel and forms the gradient.

2. The method of claim 1 wherein the channel has a generally v-shaped configuration.

3. The method of claim 1 wherein the channel is generally linear.

4. The method of claim 1 wherein the sink reservoir, the source reservoir and the channel have corresponding volumes, the volume of the sink reservoir being greater than the sum of the volumes of the source reservoir and the channel.

5. The method of claim 1 wherein the sink reservoir and the source reservoir have corresponding volumes, the volume of the sink reservoir being generally equal to the volume of the source reservoir.

6. The method of claim 1 comprising the additional step of replenishing the soluble factor in source reservoir to maintain the gradient in a generally pseudo-steady state.

7. The method of claim 1 further comprising the additional steps of:
filling the sink reservoir with a fluid; and
replacing the fluid in the sink reservoir.

8. The method of claim 1 comprising the additional step of providing an access port in the microfluidic device, the access port communicating with the channel.

9. A method of generating a gradient within a channel of a microfluidic device, the microfluidic device having a channel including an input and an output, the method comprising the steps of:
filling the channel with a gel;
filling a source reservoir in communication with the input of the channel with a first fluid;
filling a sink reservoir in communication with the output of the channel with a second fluid; and
depositing a soluble factor in the source reservoir such that the soluble factor diffuses into the channel and forms the gradient

10. The method of claim 9 comprising the additional step of polymerizing the gel.

11. The method of claim 9 wherein the channel has a generally v-shaped configuration.

12. The method of claim 9 wherein the channel is generally linear.

13. The method of claim 9 wherein the sink reservoir, the source reservoir and the channel have corresponding volumes, the volume of the sink reservoir being greater than the sum of the volumes of the source reservoir and the channel.

14. The method of claim 9 wherein the sink reservoir and the source reservoir have corresponding volumes, the volume of the sink reservoir being generally equal to the volume of the source reservoir.

15. The method of claim 9 comprising the additional step of replenishing the soluble factor in source reservoir to maintain the gradient in a generally pseudo-steady state.

16. The method of claim 9 comprising the additional step of providing an access port in the microfluidic device, the access port communicating with the channel.

17. A method of generating a gradient within a channel of a microfluidic device, the microfluidic device having a channel including an input and an output, the method comprising the steps of:
filling the channel with a gel;
polymerizing the gel within the channel;
filling a source reservoir in communication with the input of the channel with a first fluid;
filling a sink reservoir in communication with the output of the channel with a second fluid;
depositing a soluble factor in the source reservoir such that the soluble factor diffuses into the channel and forms the gradient;
replenishing the soluble factor in source reservoir to maintain the gradient in a generally pseudo-steady state; and
replacing the second fluid in the sink reservoir.

18. The method of claim 17 wherein the channel has a generally v-shaped configuration.

19. The method of claim 17 wherein the channel is generally linear.

20. The method of claim 17 wherein the sink reservoir, the source reservoir and the channel have corresponding volumes, the volume of the sink reservoir being greater than the sum of the volumes of the source reservoir and the channel.

21. The method of claim 17 wherein the sink reservoir and the source reservoir have corresponding volumes, the volume of the sink reservoir being generally equal to the volume of the source reservoir.

22. The method of claim 17 comprising the additional step of providing an access port in the microfluidic device, the access port communicating with the channel.
